(19) United States
(12) Patent Application Publication
(10) Pub. No.: US 2022/0147888 A1
(43) Pub. Date: May 12, 2022

(54) DEVICE FOR EXTRACTING FACILITY NEEDING LIGHTNING COUNTERMEASURES, METHOD FOR EXTRACTING FACTILITY NEEDING LIGHTNING COUNTERMEASURES, AND PROGRAM FOR EXTRACTING FACILITY NEEDING LIGHTNING COUNTERMEASURES

(71) Applicant: Nippon Telegraph and Telephone Corporation, Tokyo (JP)

(72) Inventors: Naomichi Nakamura, Tokyo (JP); Nobue Aoki, Tokyo (JP); Jun KATO, Tokyo (JP)

(21) Appl. No.: 17/434,644

(22) PCT Filed: Feb. 19, 2020
(86) PCT No.: PCT/JP2020/006396

§ 371 Date: Aug. 27, 2021

(30) Foreign Application Priority Data
Mar. 4, 2019 (JP) 2019-038603

(51) Int. Cl. G06Q 10/06; G06Q 50/16; G06N 20/00

(52) U.S. Cl. CPC G06Q 10/0635; G06N 20/00; G06Q 50/163

(57) ABSTRACT

Outdoor lightning countermeasure requiring facilities are effectively predicted. A facility information analysis unit 121 reads lightning strike information, lightning damage failure information on facilities when lightning strikes, and facility information from a recording unit 110 to extract facility information on facilities in which a lightning damage failure has occurred and facility information on facilities in which a lightning damage failure has not occurred. A parameter analysis unit 122 parameterizes items associated with the spots of the extracted facility information in which a lightning damage failure has occurred. A prediction model construction unit 131 performs the machine learning of the parameterized facility information to generate a prediction model that outputs the possibilities of the occurrence of a lightning damage failure in facilities when lightning strikes. A prediction unit 133 inputs the facility information to the prediction model to predict facilities in which a lightning damage failure is likely to occur when lightning strikes.

### TECHNICAL FIELD

The present invention relates to a technology to extract outdoor lightning countermeasure requiring facilities.

### BACKGROUND ART

Conventionally, there have been known technologies to predict failures due to lightning strikes (hereinafter called “lightning damage failures”) from the number of lightning strikes in specific areas, the number of installed devices, and the number of devices broken down due to lightning strikes (see, for example, PTL 1, PTL 2, or PTL 3). Then, the installation of lightning countermeasure products in facilities located in areas in which lightning damage failure risks are high has been performed as countermeasures.

### CITATION LIST

### [Patent Literature]

[PTL 1] Japanese Patent Application Laid-open No. 2004-062521

[PTL 2] Japanese Patent Application Laid-open No. 2008-015620

[PTL 3] Japanese Patent Application Laid-open No. 2009-015450

### SUMMARY OF THE INVENTION

### [Technical Problem]

The conventional technologies are technologies to predict areas in which lightning damage failures frequently occur. Therefore, the conventional technologies have been unable to specify “facilities that require lightning countermeasures” in predicted areas. That is, the conventional technologies predict lightning damage failures on an area-by-area basis and therefore have been unable to predict the requirement of lightning countermeasures for respective facilities.

The present invention has been made with attention paid to the above circumstances and has an object of effectively predicting outdoor lightning countermeasure requiring facilities.

### [Means for Solving the Problem]

A lightning countermeasure requiring facility extraction device according to the present invention includes: a parameter extraction unit that extracts facility information on facilities in which a lightning damage failure has occurred and facility information on facilities in which a lightning damage failure has not occurred when lightning strikes from lightning strike information, lightning damage failure information on facilities when lightning strikes, and facility information on the facilities; a machine learning unit that performs machine learning of the extracted facility information and generates a prediction model that, upon receiving facility information on facilities, outputs possibilities of occurrence of a lightning damage failure in the facilities when lightning strikes; and a prediction unit that inputs facility information on facilities to the prediction model and predicts the facilities in which a lightning damage failure is likely to occur when lightning strikes.

### [Effects of the Invention]

According to the present invention, outdoor lightning countermeasure requiring facilities can be effectively predicted.

### BRIEF DESCRIPTION OF DRAWINGS

FIG. 1 is a function block diagram showing the configuration of the lightning countermeasure requiring facility extraction device of an outdoor facility according to an embodiment.

FIG. 2 is a diagram showing an example of lightning strike information recorded on a lightning strike recording unit.

FIG. 3 is a diagram showing an example of lightning damage failure information recorded on a lightning damage failure recording unit.

FIG. 4A is a diagram showing an example of facility information recorded on a facility information recording unit.

FIG. 4B is a diagram showing an example of facility information recorded on the facility information recording unit.

FIG. 5A is a diagram showing an example of the parameterization of facility information.

FIG. 5B is a diagram showing an example of the parameterization of facility information.

FIG. 5C is a diagram showing an example of the parameterization of facility information.

FIG. 6A is a diagram showing a dividing example of data sets.

FIG. 6B is a diagram showing a dividing example of data sets.

FIG. 7 is a flowchart showing the flow of prediction model generation processing.

FIG. 8 is a flowchart showing the flow of prediction processing.

### DESCRIPTION OF EMBODIMENTS

Hereinafter, an embodiment of the present invention will be described with reference to the drawings.

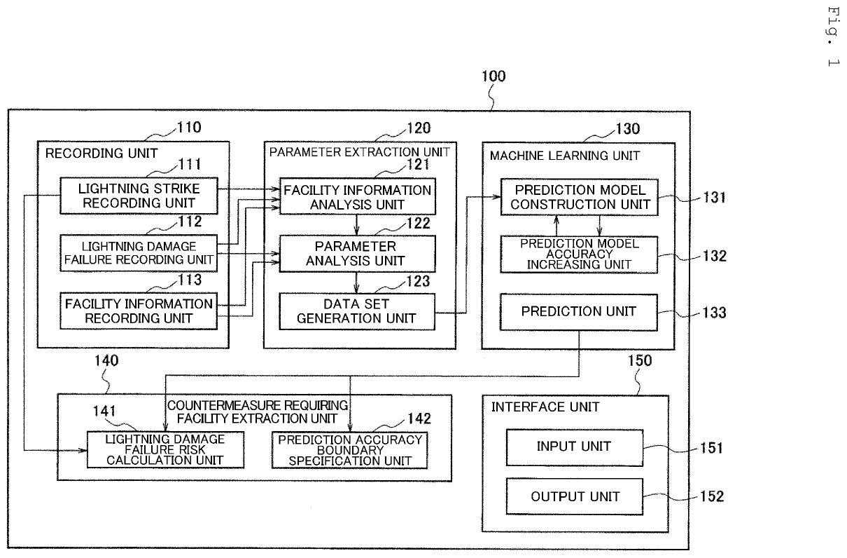

FIG. 1 is a function block diagram showing the configuration of a lightning countermeasure requiring facility extraction device 100 of an outdoor facility according to the embodiment of the present invention. Hereinafter, utility poles will be described as an example of outdoor facilities, but the outdoor facilities are not limited to the utility poles.

The lightning countermeasure requiring facility extraction device 100 shown in FIG. 1 includes a recording unit 110, a parameter extraction unit 120, a machine learning unit 130, a countermeasure requiring facility extraction unit 140, and an interface unit 150. The respective units of the lightning countermeasure requiring facility extraction device 100 may be constituted by a computer including a computation processing device, a storage device, or the like, and the processing of the respective units may be performed by a program. The program is stored in the storage device of the lightning countermeasure requiring facility extraction device 100 and may be recorded on a recording medium such as a magnetic disk, an optical disc, and a semiconductor memory or supplied via a network.

The recording unit 110 includes a lightning strike recording unit 111, a lightning damage failure recording unit 112, and a facility information recording unit 113.

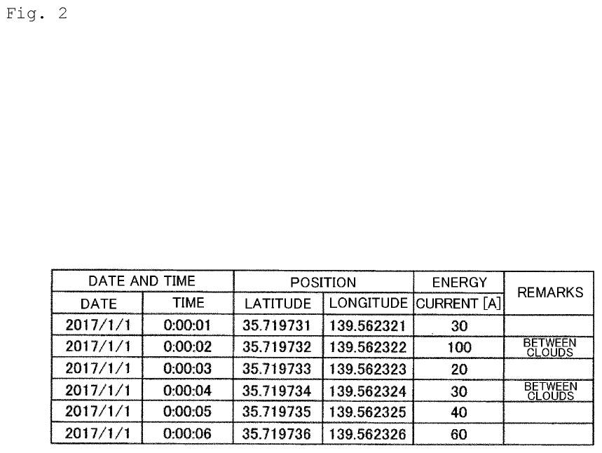

On the lightning strike recording unit 111, lightning strike information such as the dates and times and the positions of the occurrence of lightning strikes and the energy (intensity) of the lightning strikes is recorded as shown in, for example, FIG. 2.

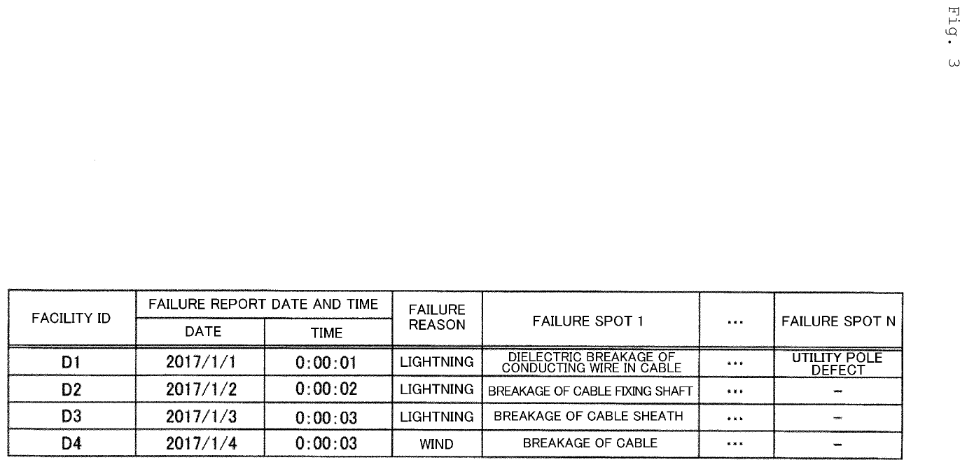

On the lightning damage failure recording unit 112, reasons for the failures of facilities and detailed information are recorded. On the lightning damage failure recording unit 112, lightning damage failure information such as the IDs of utility poles (hereinafter called “facility IDs”), failure report dates and times, failure reasons, and failure spots 1 to N is recorded as shown in, for example, FIG. 3. The failure report dates and times refer to dates and times at which the occurrence of failures was reported.

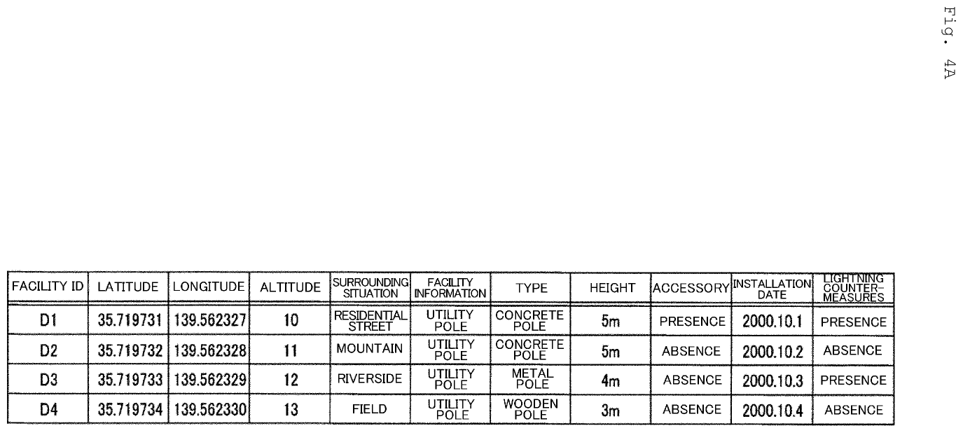

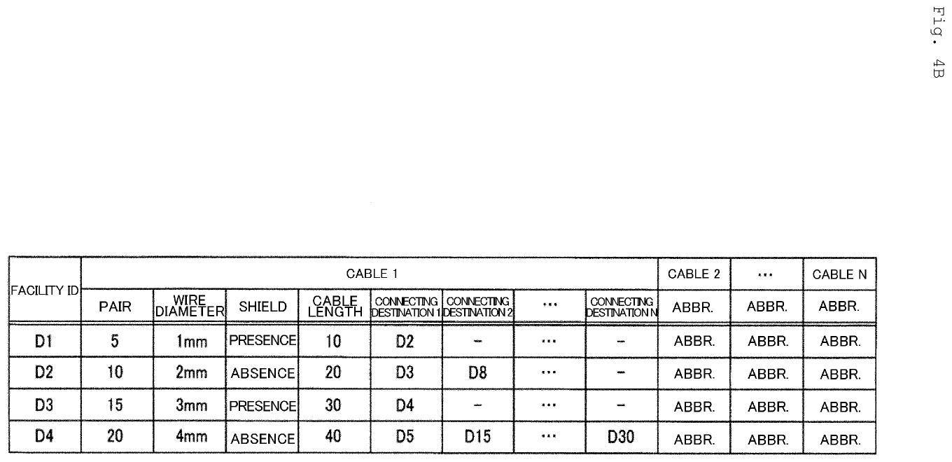

On the facility information recording unit 113, facility information on facilities is recorded. On the facility information recording unit 113, facility information such as facility IDs, position information (latitudes and longitudes), altitudes, information on surrounding situations, facility information, facility types, the heights of utility poles, accessories (for example, pole transformers, street lamps, name boards, or the like), installation dates, and the presence or absence of lightning countermeasures is recorded as shown in, for example, FIG. 4A. Further, on the facility information recording unit 113, information on cables 1 to N connected to utility poles is recorded for each of facility IDs as shown in FIG. 4B. Here, the cables refer to cables in which a plurality of conducting wires are bundled together. As the information on the cables 1 to N, the number of the pairs of the cables (for example, in the case of two pairs of conducting wires, a number obtained by dividing the number of the conducting wires by two (pairs) becomes the number of pairs), the wire diameters of the respective conducting wires, the presence or absence of a shield, cable lengths (distances to next utility poles), and information on connecting destinations 1 to N (facility IDs or the like of the connecting destinations) of the cables are recorded. In addition, the presence or absence of the connecting points of the cables, the determination of points at which different types of cables are connected to each other (cables having different wire diameters are connected to each other, cables having different pairs are connected to each other, or the like), the presence or absence of the branches of the cables, or the like may be recorded.

The parameter extraction unit 120 includes a facility information analysis unit 121, a parameter analysis unit 122, and a data set generation unit 123.

The facility information analysis unit 121 reads lightning damage failure information within a certain time (for example, within three hours, within a few days, or the like) from the date and time of the occurrence of a lightning strike from the lightning strike recording unit 111 and the lightning damage failure recording unit 112 and extracts facility information on “facilities in which a lightning damage failure has occurred due to a lightning strike”. In addition, the facility information analysis unit 121 extracts facility information on “facilities in which a lightning damage failure has not occurred in spite of a lightning strike” from the lightning strike recording unit 111, the lightning damage failure recording unit 112, and the facility information recording unit 113. In the present embodiment, a case in which a lightning strike has occurred within a radius of 300 m about a facility (utility pole) is, for example, determined as the “occurrence of a lightning strike”. Lightning strike positions recorded on the lightning strike recording unit 111 contain observation errors and are therefore required to be subjected to correction such as “within a radius of 300 m” or the like. Further, a lightning damage failure occurs at timing at which a lightning strike occurs, but a report on the occurrence of the lightning damage failure (recording on the lightning damage failure recording unit 112) takes time. Therefore, a time lag within a certain time from the date and time of the occurrence of a lightning strike is set. Further, by comparing lightning strike information and lightning damage failure information with each other, the facility information analysis unit 121 can reliably extract only the lightning damage failure information. A lightning damage failure does not occur if a lightning strike does not occur. Therefore, information recorded as a lightning damage failure although a lightning strike has not occurred is a mistake in determining a reason for the failure.

The parameter analysis unit 122 reads information recorded on the lightning damage failure recording unit 112 and the facility information recording unit 113 about facilities extracted by the facility information analysis unit 121 and predominantly extracts items that are recorded on the lightning damage failure recording unit 112 and associated with spots in which a lightning damage failure has occurred (failure spots of utility poles). Then, the parameter analysis unit 122 uses the values of the extracted items as parameters for machine learning that are required to generate a prediction model. The prediction model refers to a model that, upon receiving various parameters obtained by parameterizing facility information from the parameter analysis unit 122, outputs prediction results showing the possibilities of a lightning damage failure in facilities when a lightning strike occurs in the facilities.

Examples of extracting items associated with lightning damage failure spots by the parameter analysis unit 122 will be described. If there is a record on the dielectric breakage of a conducting wire in a cable, an item associated with the conducting wire of a utility pole in which a lightning damage failure has occurred is extracted. If there is a record on the breakage of a cable fixing jig, an item associated with the cable fixing jig of a utility pole is extracted. If there is a record on the breakage of a cable sheath, an item associated with the cable sheath of a utility pole is extracted.

Further, the parameter analysis unit 122 extracts a plurality of utility poles in which a lightning damage failure has occurred, compares the various items of the respective utility poles with each other, extracts items common to the utility poles in which the lightning damage failure has occurred other than the spots (items) of the occurrence of the lightning damage failure, and uses the extracted items as parameters for machine learning. For example, when extracting a plurality of utility poles in which a lightning damage failure has occurred (failure spots are different), the parameter analysis unit 122 extracts an item such as the presence of a connecting point (or a branching point) in a cable, the installation of a cable having the smallest core wire diameter, and the installation of a utility pole shaped transformer, each of which is common to most of the utility poles.

For the parameterization of facility information, not only items associated with spots in which a lightning damage failure has occurred but also information (information on cables installed in utility poles, surrounding environments, or the like) characterizing facility configurations are also important to increase accuracy in a prediction model and therefore extracted as parameters. Since the facilities broken down by a lightning strike have tendencies, the use of the tendencies of failure spots as parameters allows high-accuracy learning.

Note that, when facility information does not include the branches of cables or connecting point information, it can be determined that there are branches or connecting points if the number of upper cables is different from the number of lower cables in target utility poles. Further, when facility information does not include surrounding information on utility poles, residential areas, fields, mountains, or the like are discriminated on the basis of the number of other utility poles around target utility poles or distances to the utility poles. For example, residential areas are discriminated when there are a plurality of utility poles at a short distance, and mountains or fields are discriminated when the number of the branches of the utility poles is small and the distances between the utility poles are long. In the manner described above, existing facility information is combined together to make a discrimination when facility information does not include a tendency by which a lightning damage failure is likely to occur.

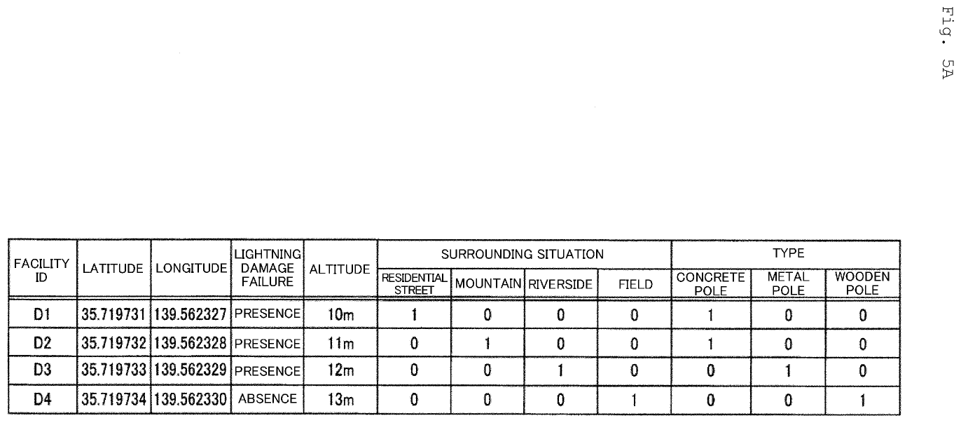

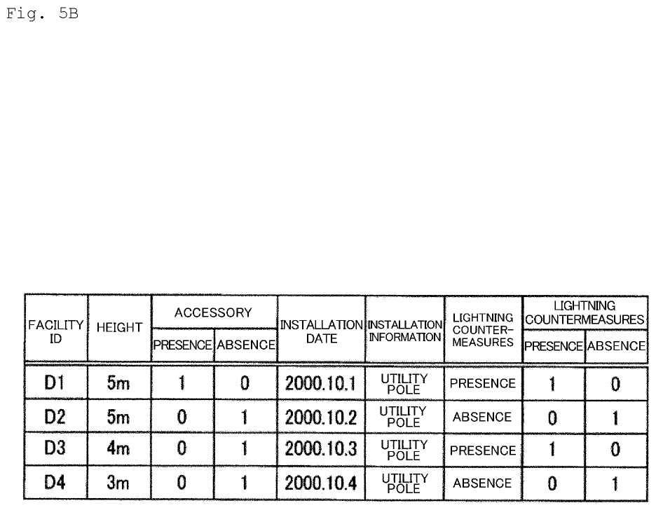

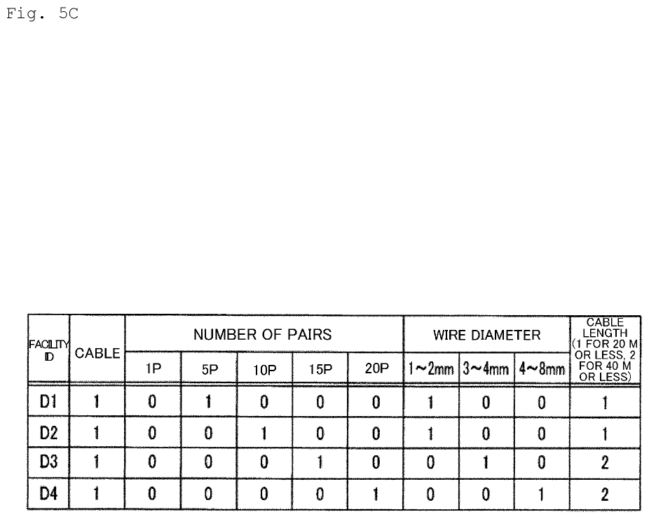

When parameterizing the values of extracted items, the parameter analysis unit 122 organizes the values of the items into data types available for machine learning. FIGS. 5A to 5C show a parameterization example. Although FIGS. 5A to 5C are shown by separate tables, the respective items of FIGS. 5A to 5C are associated with each other for each of facility IDs. As shown in FIG. 5A, the respective facility IDs include information on the presence or absence of a lightning damage failure. The machine learning unit 130 that will be described later generates a prediction model using both data on facilities in which a lightning damage failure has occurred and data on facilities in which a lightning damage failure has not occurred.

In a parameterization, when numeric data is input to the items of the facility information of the facility information recording unit 113 like, for example, altitudes in FIG. 5A, the parameter analysis unit 122 directly parameterizes the numeric data to perform parameterization. When “presence/absence” is input to items like an accessory and lightning countermeasures in FIG. 5B, the parameter analysis unit 122 converts presence and absence into “1” and “0”, respectively, to perform parameterization. Further, when “types” are input to items like a surrounding situation and a facility type in FIG. 5A, the parameter analysis unit 122 sets parameter items corresponding to the number of the types and puts 1 and 0 in corresponding parameter items and non-corresponding parameter items, respectively, to perform parameterization.

Further, in the case of numeric data such as the pairs and wire diameters of cables that are not sequential numeric values and can be classified into several types, the parameter analysis unit 122 may set a parameter item for each of the values and put 1 and 0 in corresponding parameter items and non-corresponding items, respectively, to perform parameterization as shown in FIG. 5C. Alternatively, as shown in a cable length in FIG. 5C, the parameter analysis unit 122 may classify numeric data into levels and put numeric values showing corresponding levels in items.

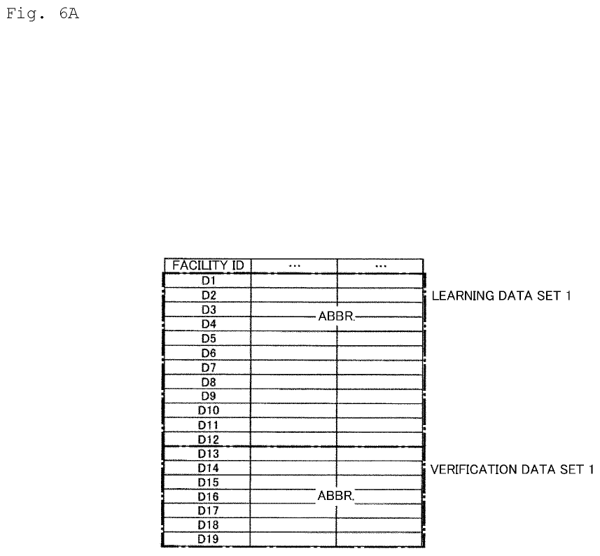

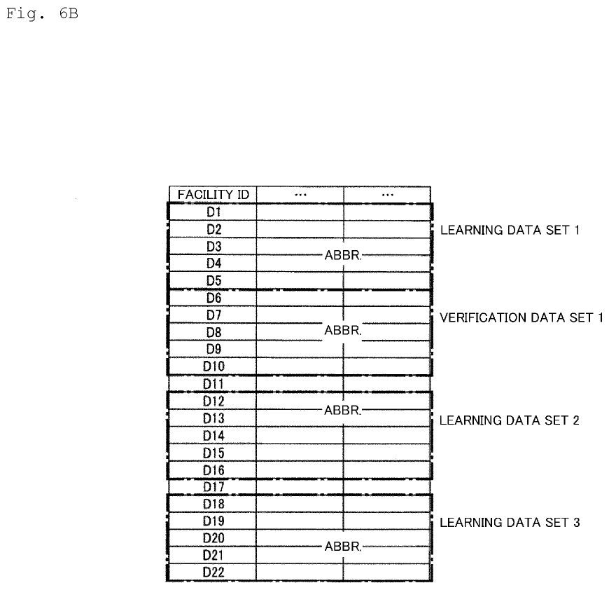

The data set generation unit 123 divides facility information parameterized by the parameter analysis unit 122 into one or more learning data sets (groups of learning parameters) and one or more verification data sets (groups of verification parameters). A method for dividing facility information is performed in various ways, and it is assumed that the division of the facility information is performed randomly, for each period, for each area, for each failure spot, or the like. FIGS. 6A and 6B show examples of dividing facility information into data sets. As shown in FIG. 6A, the data set generation unit 123 may divide parameterized facility information into two, i.e., a learning data set and a verification data set. As shown in FIG. 6B, the data set generation unit 123 may divide parameterized facility information into a plurality of learning data sets and a plurality of verification data sets. When facility information is divided into a plurality of learning data sets, the machine learning unit 130 generates prediction models using each of the plurality of learning data sets and employs a prediction model with highest accuracy. Further, the machine learning unit 130 generates prediction models according to different dividing methods and employs a prediction model with the highest accuracy.

The machine learning unit 130 includes a prediction model construction unit 131, a prediction model accuracy increasing unit 132, and a prediction unit 133.

The prediction model construction unit 131 generates a prediction model according to a previously-specified machine learning algorithm (such as a logistic regression analysis and deep learning) using a learning data set divided (for generating a prediction model) for machine learning by the data set generation unit 123. In generating a prediction model, the prediction model construction unit 131 may not use a specific machine learning method but may use various machine learning methods to construct the prediction model and select a machine learning method with the highest accuracy.

The prediction model accuracy increasing unit 132 inputs a learning data set and a verification data set to a prediction model generated by the prediction model construction unit 131 to calculate output results and verifies a matching rate between the output results and the presence or absence of an actual lightning damage failure. In generating a prediction model, the prediction model accuracy increasing unit 132 changes a learning data set used for learning or changes a dividing method for a learning data set and a verification data set until accuracy in a prediction model increases. In order to generate a prediction model with high accuracy, the prediction model accuracy increasing unit 132 may repeatedly perform the generation of a prediction model for a prescribed number of times or for a prescribed time interval.

After generating a prediction model with the highest accuracy, the prediction model accuracy increasing unit 132 transmits the prediction model to the prediction unit 133.

The prediction unit 133 inputs various parameters extracted from the facility information recording unit 113 via the parameter analysis unit 122 to a prediction model for respective facilities and predicts the possibilities of the occurrence of a lightning damage failure in the facilities when a lightning strike occurs in the respective facilities. The parameters input to the prediction model are the same as learning parameters and verification parameters used for generating the prediction model.

The countermeasure requiring facility extraction unit 140 includes a lightning damage failure risk calculation unit 141 and a prediction accuracy boundary specification unit 142.

The lightning damage failure risk calculation unit 141 reads lightning strike information from the lightning strike recording unit 111, calculates a lightning damage failure risk (for example, a lightning strike occurrence frequency, lightning strike intensity, and the number of the times of the occurrence of a lightning damage failure in the past) for each of areas, and generates a distribution map of the lightning damage failure risks (a distribution map of lightning strike occurrence frequencies, a distribution map of lightning strike intensity (energy), a distribution map of the number of the times of the occurrence of a lightning damage failure in the past, or the like). By extracting only facilities in which a lightning damage failure is likely to occur according to the prediction results of the prediction unit 133 and which are located in areas in which a lightning damage failure risk in a distribution map generated by the lightning damage failure risk calculation unit 141 is higher than a prescribed threshold (areas in which a lightning strike occurrence frequency is higher than a prescribed threshold, areas in which lightning strike intensity is higher than a prescribed threshold, areas in which the number of the times of a lightning damage failure is greater than a prescribed threshold, or the like) as countermeasure requiring facilities, the countermeasure requiring facility extraction unit 140 is allowed to narrow down lightning countermeasure requiring facilities. The lightning damage failure risk calculation unit 141 may extract facilities in which a lightning damage failure is likely to occur in descending order of lightning strike occurrence frequencies or in descending order of lightning strike intensity. Here, lightning strike occurrence frequencies, lightning strike intensity, and the number of the times of the occurrence of a lightning damage failure in the past are illustrated as lightning damage failure risks, but values calculated from other lightning damage failure prediction technologies (for example, PTL 1 to PTL 3) may be used.

The prediction accuracy boundary specification unit 142 extracts only facilities in which a lightning damage failure is likely to occur according to the prediction results of the prediction unit 133 and which shows prediction accuracy higher than a prescribed threshold. The prediction accuracy refers to a numeric value output by the prediction unit 133 together with a prediction result. For example, a value that is between 0 and 1 and closer to 1 shows higher prediction accuracy (a classification probability in a logistic regression). By extracting only values showing high prediction accuracy, the prediction accuracy boundary specification unit 142 can effectively select lightning countermeasure requiring facilities. The prediction accuracy boundary specification unit 142 may extract facilities in which a lightning damage failure is likely to occur in descending order of prediction accuracy.

The interface unit 150 includes an input unit 151 and an output unit 152. The input unit 151 refers to a monitor, a keyboard, or the like used when information is written on the recording unit 110. The output unit 152 refers to a monitor, a printer, or the like that displays output results.

Next, the prediction model generation processing and the prediction processing of the lightning countermeasure requiring facility extraction device 100 of the present embodiment will be described.

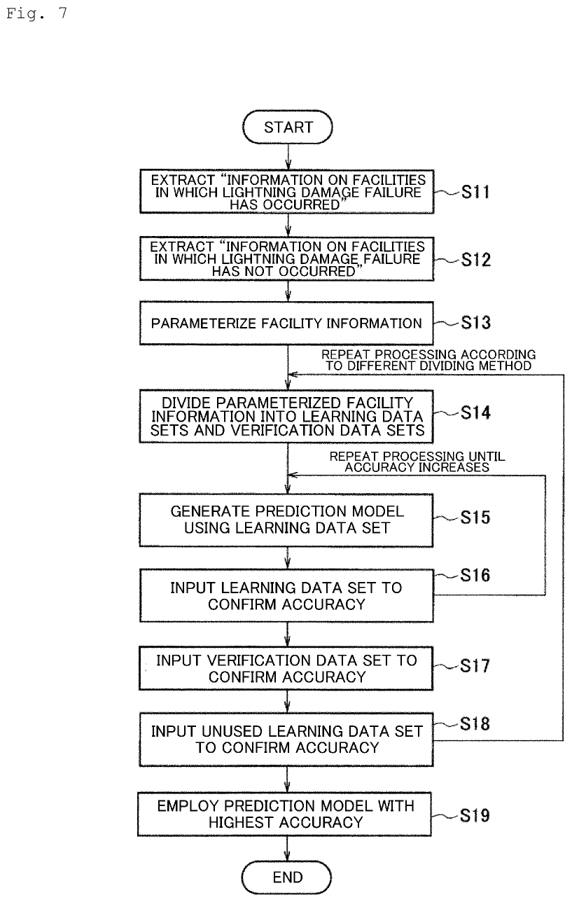

FIG. 7 is a flowchart showing the flow of the prediction model generation processing.

In step S11, the facility information analysis unit 121 extracts “facilities in which a lightning damage failure has occurred due to a lightning strike”.

In step S12, the facility information analysis unit 121 extracts “facilities in which a lightning damage failure has not occurred in spite of a lightning strike”.

In step S13, the parameter analysis unit 122 reads facility information on neighborhood facilities in which a lightning strike has occurred, that is, facility information on the facilities extracted in steps S11 and S12 from the facility information recording unit 113 and parameterizes the read facility information.

In step S14, the data set generation unit 123 divides the parameterized facility information into learning data sets and verification data sets. The number of the facilities of the respective data sets may be arbitrarily set.

In step S15, the prediction model construction unit 131 generates a prediction model using the learning data sets.

A learning data set to be used for generating the prediction model may be selected randomly or in turn from among the plurality of learning data sets divided by the data set generation unit 123.

In step S16, the prediction model accuracy increasing unit 132 inputs the learning data set used in step S15 to the prediction model generated in step S15 and verifies a matching rate between output results and the presence or absence of an actual lightning damage failure. The processing proceeds to the processing of step S17 if accuracy in the output results is high. If there is any unused learning data set, the processing returns to step S15 and the prediction model construction unit 131 generates a prediction model using another learning data set.

In step S17, the prediction model accuracy increasing unit 132 inputs a verification data set to the prediction model and verifies a matching rate between output results and the presence or absence of an actual lightning damage failure.

In step S18, the prediction model accuracy increasing unit 132 inputs a learning data set not used in step S15 to the prediction model and verifies a matching rate between output results and the presence or absence of an actual lightning damage failure.

When accuracy in the output results in steps S17 and S18 is low, the processing returns to step S14 to divide the facility information into data sets according to a different dividing method and repeatedly perform the processing of steps S14 to S18. The prediction model accuracy increasing unit 132 may repeatedly perform the processing of steps S14 to S18 for a prescribed number of times or for a prescribed time interval.

In step S19, the prediction model accuracy increasing unit 132 employs a prediction model with the highest accuracy and transmits the same to the prediction unit 133.

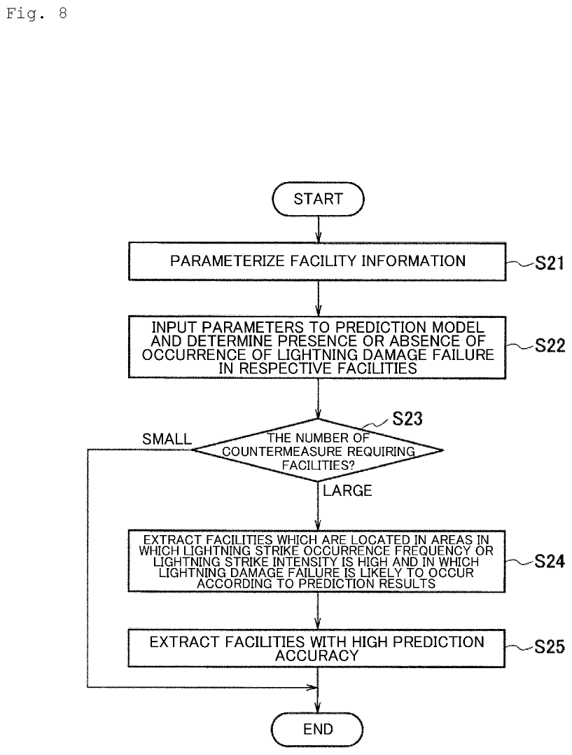

FIG. 8 is a flowchart showing the flow of the prediction processing.

In step S21, the parameter analysis unit 122 reads facility information from the facility information recording unit 113 and parameterizes the facility information to be input to a prediction model. Here, the parameter analysis unit 122 parameterizes all the facility information recorded on the facility information recording unit 113.

In step S22, the prediction unit 133 inputs the parameters of respective facilities to the prediction model and predicts the presence or absence of the occurrence of a lightning damage failure in the respective facilities.

In step S23, a determination is made as to whether the number of the facilities in which a lightning damage failure occurs is large according to the prediction results of step S22.

When the number of the facilities in which a lightning damage failure occurs is large, the lightning damage failure risk calculation unit 141 calculates in step S24 areas in which a lightning damage failure risk is high (for example, areas in which a lightning strike occurrence frequency is high, areas in which lightning strike intensity is high, or areas in which the number of the times of the occurrence of a lightning damage failure in the past is large) and extracts facilities in which a lightning damage failure is likely to occur according to the prediction results from the facilities in the areas in which the lightning strike occurrence frequency is high or in the areas in which the lightning strike intensity is high.

In step S25, the prediction accuracy boundary specification unit 142 extracts only the facilities in which a lightning damage failure is likely to occur according to the prediction results and which show high prediction accuracy.

The order of the processing of steps S24 and S25 is arbitrarily. Only one of the processing of steps S24 and S25 may be performed.

By the processing described above, lightning countermeasure requiring facilities can be extracted.

As described above, outdoor lightning countermeasure requiring facilities can be effectively predicted by the after-mentioned processing according to the present embodiment. In the processing, the facility information analysis unit 121 reads lightning strike information, lightning damage failure information on facilities when lightning strikes, and facility information from the recording unit 110 to extract facility information on facilities in which a lightning damage failure has occurred and facility information on facilities in which a lightning damage failure has not occurred. In addition, the parameter analysis unit 122 parameterizes items associated with the spots of the extracted facility information in which a lightning damage failure has occurred. In addition, the prediction model construction unit 131 performs the machine learning of the parameterized facility information to generate a prediction model that outputs the possibilities of the occurrence of a lightning damage failure in the facilities when lightning strikes. In addition, the prediction unit 133 inputs facility information to the prediction model and predicts facilities in which a lightning damage failure is likely to occur when lightning strikes.

According to the present embodiment, the lightning damage failure risk calculation unit 141 calculates lightning damage failure risks (for example, calculates a lightning strike occurrence frequency or lightning strike intensity for each of areas on the basis of lightning strike information or calculates the number of lightning damage failures for each of the areas on the basis of lightning damage failure information) and extracts only facilities in which a lightning damage failure is likely to occur according to prediction results and which are located in areas in which lightning damage failure risks are high as countermeasure requiring facilities, thereby making it possible to narrow down lightning countermeasure requiring facilities.

According to the present embodiment, the prediction accuracy boundary specification unit 142 extracts only facilities in which a lightning damage failure is likely to occur according to prediction results and in which prediction accuracy is higher than a prescribed threshold as countermeasure requiring facilities, thereby making it possible to narrow down lightning countermeasure requiring facilities.

### REFERENCE SIGNS LIST

100 Lightning countermeasure requiring facility extraction device
110 Recording unit
111 Lightning strike recording unit
112 Lightning damage failure recording unit
113 Facility information recording unit
120 Parameter extraction unit
121 Facility information analysis unit
122 Parameter analysis unit
123 Data set generation unit
130 Machine learning unit
131 Prediction model construction unit
132 Prediction model accuracy increasing unit
133 Prediction unit
140 Countermeasure requiring facility extraction unit
141 Lightning damage failure risk calculation unit
142 Prediction accuracy boundary specification unit
150 Interface unit
151 Input unit
152 Output unit

1. A lightning countermeasure requiring facility extraction device comprising: a parameter extraction unit, including one or more processors, configured to extract facility information on facilities in which a lightning damage failure has occurred and facility information on facilities in which a lightning damage failure has not occurred when lightning strikes from lightning strike information, lightning damage failure information on facilities when lightning strikes, and facility information on the facilities; a machine learning unit, including one or more processors, configured to perform machine learning of the extracted facility information and generates a prediction model that, upon receiving facility information on facilities, outputs possibilities of occurrence of a lightning damage failure in the facilities when lightning strikes; and a prediction unit, including one or more processors, configured to input facility information on facilities to the prediction model and predicts the facilities in which a lightning damage failure is likely to occur when lightning strikes.

2. The lightning countermeasure requiring facility extraction device according to claim 1, comprising: a first facility extraction unit, including one or more processors, configured to calculate a lightning damage failure risk for each area on a basis of the lightning strike information and extracts a facility in an area in which the lightning damage failure risk is higher than a prescribed threshold from the facilities in which a lightning damage failure is likely to occur.

3. The lightning countermeasure requiring facility extraction device according to claim 1, wherein the prediction unit is configured to output prediction accuracy together with prediction results, the lightning countermeasure requiring facility extraction device comprising a second facility extraction unit that extracts a facility having the prediction accuracy higher than a prescribed threshold from the facilities in which a lightning damage failure is likely to occur.

4. A lightning countermeasure requiring facility extraction method comprising: a step of extracting facilities in which a lightning damage failure has occurred and facilities in which a lightning damage failure has not occurred when lightning strikes from lightning strike information, lightning damage failure information on facilities when lightning strikes, and facility information on the facilities; a step of performing machine learning of information on the extracted facility and generating a prediction model that, upon receiving facility information on facilities, outputs possibilities of occurrence of a lightning damage failure in the facilities when lightning strikes; and a step of inputting facility information on facilities to the prediction model and predicts the facilities in which a lightning damage failure is likely to occur when lightning strikes.

5. The lightning countermeasure requiring facility extraction method according to claim 4, comprising: a step of calculating a lightning damage failure risk for each area on a basis of the lightning strike information; and a step of extracting a facility in an area in which the lightning damage failure risk is higher than a prescribed threshold from the facilities in which a lightning damage failure is likely to occur.

6. The lightning countermeasure requiring facility extraction method according to claim 4, wherein prediction accuracy is output together with prediction results in the step of predicting the facilities in which a lightning damage failure is likely to occur when lightning strikes, the lightning countermeasure requiring facility extraction method comprising a step of extracting a facility having the prediction accuracy higher than a prescribed threshold from the facilities in which a lightning damage failure is likely to occur.

7. A non-transitory computer readable medium storing a lightning countermeasure requiring facility extraction program causing a computer to operate as respective units of a lightning countermeasure requiring facility extraction device wherein the respective units comprise:
a parameter extraction unit configured to extract facility information on facilities in which a lightning damage failure has occurred and facility information on facilities in which a lightning damage failure has not occurred when lightning strikes from lightning strike information, lightning damage failure information on facilities when lightning strikes, and facility information on the facilities;
a machine learning configured to perform machine learning of the extracted facility information and generates a prediction model that, upon receiving facility information on facilities, outputs possibilities of occurrence of a lightning damage failure in the facilities when lightning strikes; and
a prediction unit configured to input facility information on facilities to the prediction model and predicts the facilities in which a lightning damage failure is likely to occur when lightning strikes.

8. The non-transitory computer readable medium according to claim 7, wherein the respective units further comprise: a first facility extraction unit configured to calculate a lightning damage failure risk for each area on a basis of the lightning strike information and extracts a facility in an area in which the lightning damage failure risk is higher than a prescribed threshold from the facilities in which a lightning damage failure is likely to occur.

9. The non-transitory computer readable medium according to claim 7, wherein the prediction unit is configured to output prediction accuracy together with prediction results, the lightning countermeasure requiring facility extraction device comprising a second facility extraction unit that extracts a facility having the prediction accuracy higher than a prescribed threshold from the facilities in which a lightning damage failure is likely to occur.
